(19) United States
(12) Patent Application Publication
(10) Pub. No.: US 2024/0278842 A1
(43) Pub. Date: Aug. 22, 2024

(54) STRUCTURAL BODY

(71) Applicant: TOYOTA JIDOSHA KABUSHIKI KAISHA, Toyota-shi (JP)

(72) Inventor: Shinji TATEYAMA, Toyota-shi (JP)

(21) Appl. No.: 18/408,585

(22) Filed: Jan. 10, 2024

(30) Foreign Application Priority Data
Feb. 22, 2023 (JP) 2023-026749

(51) Int. Cl. B62D 21/15

(52) U.S. Cl. CPC B62D 21/155

(57) ABSTRACT

A structural body, which is integrally molded by die casting and which is configured to form a vehicle skeleton, the structural body including a portion at one end side and a portion at another end side that respectively have different metal properties.

### CROSS-REFERENCE TO RELATED APPLICATION

This application is based on and claims priority under 35 USC 119 from Japanese Patent Application No. 2023-026749, filed on Feb. 22, 2023, the entire disclosure of which is incorporated by reference herein.

### BACKGROUND

### Technical Field

The present disclosure relates to a structural body that is integrally molded by die casting.

### Related Art

International Publication (WO) No. 2022/031991 discloses a technique in which a structure including a side member provided with an energy absorption structure is integrally molded by die casting.

Structural bodies integrally molded by die casting have hitherto been manufactured such that differences in metal properties in different portions are small; however, ideal metal properties differ from portion to portion since conventionally multiple component functionalities exist alongside each other. In the structure described in WO No. 2022/031991, portions are characterized according to the shape of the structure, and are not divided by metal properties.

### SUMMARY

The present disclosure provides a structural body that is integrally molded by die casting, and that has different metal properties, such that different functions corresponding to respective metal properties can be provided alongside each other.

A structural body according to a first aspect of the present disclosure is integrally molded by die casting and is configured to form a vehicle skeleton, and includes a first portion at one end side and a second portion at another end side, the first and second portions respectively having different metal properties.

In the structural body according to the first aspect of the present disclosure, in a structure that is integrally molded by die casting and forms a vehicle skeleton, metal properties are different between a first portion at one end side and a second portion at another end side. This enables different functions corresponding to respective metal properties to be provided as a result of having different metal properties in an integrally molded structure.

A structural body according to a second aspect of the present disclosure has the configuration of the first aspect, in which the structural body configures a vehicle front portion or a vehicle rear portion, the second portion is disposed at an outer side, in a vehicle front-rear direction, relative to the first portion, and the second portion has a metal property that is at least one of lower strength or higher ductility than the first portion.

The structural body according to the second aspect of the present disclosure is a structure configuring a vehicle front portion or a vehicle rear portion, and the second portion at the other end side is disposed at the vehicle front-rear direction outer side of the first portion at the one end side, and the second portion at the other end side has a metal property that is at least one of lower strength and higher ductility than the first portion at the one end side. This enables the metal property of the second portion disposed at the vehicle outer side to be at least one of a lower strength or a higher ductility than the first portion disposed at the vehicle inner side. As a result, by imparting the portion at the vehicle outer side with higher ductility than the portion at the vehicle inner side, the energy absorption performance of the portion at the vehicle outer side can be improved. Further, by imparting the portion at the vehicle outer side with lower strength than the portion at the vehicle inner side, the portion at the vehicle inner side can be made harder to deform. Further, because the vehicle inner side portion is stronger than the vehicle outer side portion, the rigidity of the vehicle inner side portion is higher than the rigidity of the vehicle outer side portion, enabling maneuverability to be improved.

A structural body according to a third aspect of the present disclosure has the configuration of the second aspect, in which the second portion includes at least a part of a front side member.

In the structural body according to the third aspect of the present disclosure, since the second portion including at least a part of the front side member, the portion including at least a part of the front side member can be imparted with higher ductility than other portions. This enables a portion that is not to be deformed and a portion that is to be deformed to be integrally molded, and the energy absorption performance of the portion including at least a part of the front side member can be improved.

A structural body according to a fourth aspect of the present disclosure has the configuration of the third aspect, in which the second portion, which includes at least a part of a front side member, is a crash box.

In the structural body according to the fourth aspect of the present disclosure, since the second portion including at least a part of the front side member is a crash box, the crash box can be imparted with higher ductility than other portions. This enables the crash box to be integrally molded with other components that require strength.

As explained above, the structural body according to the present disclosure has different metal properties in a structure that is integrally molded by die casting, such that different functions corresponding to respective metal properties can be provided in combination.

### BRIEF DESCRIPTION OF THE DRAWINGS

Exemplary embodiments of the present disclosure will be described in detail based on the following figures, wherein:

FIG. 1 is a plan view schematically illustrating an example of a main portion of a vehicle front portion including a structural body according to a first exemplary embodiment of the present disclosure;

FIG. 2 is a perspective view from an oblique front side of an example of a main portion of a vehicle front portion including the structural body of FIG. 1;

FIG. 3A is a schematic view schematically illustrating a manufacturing process of a structural body according to a first exemplary embodiment of the present disclosure;

FIG. 3B is a schematic view schematically illustrating a manufacturing process of a structural body according to a first exemplary embodiment of the present disclosure;

FIG. 3C is a schematic view schematically illustrating a manufacturing process of a structural body according to a first exemplary embodiment of the present disclosure;

FIG. 3D is a schematic view schematically illustrating a manufacturing process of a structural body according to a first exemplary embodiment of the present disclosure;

FIG. 4 is a flowchart illustrating an example of a series of treatment in a manufacturing process of a structural body according to a first exemplary embodiment of the present disclosure;

FIG. 5 is a graph illustrating a relationship between time and temperature in a manufacturing process of a structural body according to a first exemplary embodiment of the present disclosure;

FIG. 6A is a schematic view schematically illustrating a manufacturing process of a structural body according to a second exemplary embodiment of the present disclosure;

FIG. 6B is a schematic view schematically illustrating a manufacturing process of a structural body according to a second exemplary embodiment of the present disclosure;

FIG. 6C is a schematic view schematically illustrating a manufacturing process of a structural body according to a second exemplary embodiment of the present disclosure;

FIG. 6D is a schematic view schematically illustrating a manufacturing process of a structural body according to a second exemplary embodiment of the present disclosure;

FIG. 6E is a schematic view schematically illustrating a manufacturing process of a structural body according to a second exemplary embodiment of the present disclosure;

FIG. 7 is a flowchart illustrating an example of a series of treatment in a manufacturing process of a structural body according to a second exemplary embodiment of the present disclosure;

FIG. 8 is a graph illustrating a relationship between time and temperature in a manufacturing process of a structural body according to a second exemplary embodiment of the present disclosure;

FIG. 9 is a plan view schematically illustrating an example of a main portion of a vehicle rear portion including a structural body according to a third exemplary embodiment of the present disclosure; and

FIG. 10 is a perspective view schematically illustrating an example of a main portion of a vehicle front portion including a structural body of a modified example.

### DETAILED DESCRIPTION

### Exemplary Embodiment 1

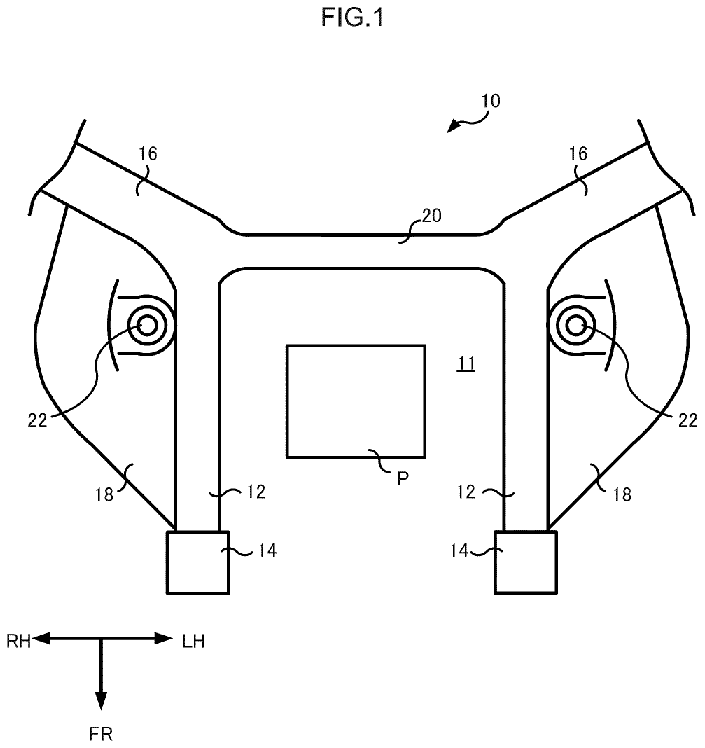

Explanation follows regarding a vehicle front structure as a structural body according to a first exemplary embodiment of the present disclosure, with reference to FIGS. 1 to 5. Note that in each of the drawings, shown as appropriate, the arrow FR indicates a front side in a vehicle front-rear direction, and the arrow UP indicates an upper side in a vehicle vertical direction. Further, the arrow LH indicates a left side in a vehicle width direction. When explanation is made using simply front and rear, up and down, and left and right directions, unless specifically stated otherwise, these indicate front and rear in the vehicle front-rear direction, up and down in the vehicle vertical direction, and left and right in the vehicle left-right direction (vehicle width direction).

### (Configuration of Vehicle Front Structure)

Explanation follows regarding a configuration of a vehicle front structure 10 as a structural body according to a first exemplary embodiment. As illustrated in FIG. 1, in the present exemplary embodiment, the vehicle front structure 10 is a structural body configuring a vehicle front portion and, as an example, is incorporated in an electric vehicle such as an electric automobile or a fuel cell automobile that runs on power generated by a power unit P. A power unit chamber 11, in which the power unit P is installed, is provided at the vehicle front portion.

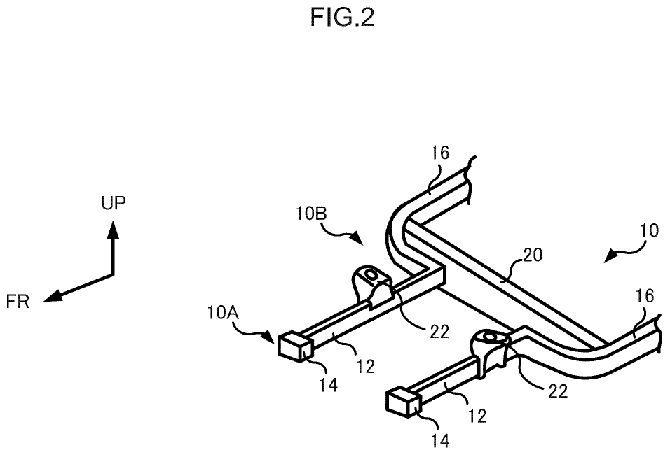

As illustrated in FIGS. 1 and 2, the vehicle front structure 10 is a front skeleton member of a vehicle, and includes a left and right pair of front side members 12 that are disposed at both vehicle width direction sides of a vehicle front portion. The front side member 12 extends in the vehicle front-rear direction, and an end portion of the front side member 12 at the vehicle rear side is connected to a cross member (not illustrated). A vehicle front end portion of the front side member 12 is connected to a front bumper reinforcement (not illustrated; hereafter, referred to as a “bumper RF”) disposed along the vehicle width direction. In the present exemplary embodiment, as an example, the front side member 12 includes a crash box 14 as an energy absorption member at a front end portion connected to the bumper RF.

The crash box 14 is configured to be deformed prior to deformation of the front side member 12 and absorb some of the energy of the collision when the vehicle is involved in a frontal collision. When an impact load is transmitted from the bumper RF to the crash box 14, the crash box 14 is compressed in the front-rear direction.

A left and right pair of apron upper members 16 extending in the vehicle front-rear direction are disposed at the vehicle width direction outer side at the vehicle rear side of the front side members 12. A left and right pair of fender aprons 18 are disposed at the vehicle width direction outer side of the front side members 12 and at the vehicle front side of the apron upper members 16. Note that illustration of the fender aprons 18 is omitted from FIG. 2. The front side member 12 and the apron upper member 16 each have a substantially rectangular cross-section shape that is open at the vehicle width direction outer side.

A dash panel 20 is disposed at the vehicle rear side of the front side members 12 and between the left and right pair of apron upper members 16. The dash panel 20 is a member that partitions the power unit chamber 11 from a vehicle cabin (not illustrated in the drawings), and extends in the vehicle width direction and the vehicle vertical direction with its plate thickness direction in the vehicle front-rear direction. An end portion of the dash panel 20 in the vehicle width direction is connected to the fender apron 18.

A suspension tower 22 is provided at a vehicle upper side and at the vehicle width direction outer side at the vehicle rear side of the vehicle front side member 12. A vehicle lower side of the suspension tower 22 is joined to the fender apron 18, the fender apron 18 is formed swollen toward the vehicle width direction inner side, and a wheel house, not illustrated in the drawings, in which a front wheel is housed so as to be capable of being steered, is also formed.

The suspension tower 22 is provided projecting in a substantial tube shape toward the vehicle upper side from the wheel house; that is, from the swollen portion of the fender apron 18. A shock absorber and a spring, configuring a non-illustrated suspension that supports a front wheel housed in the wheel house of the fender apron 18, are housed inside the suspension tower 22.

As an example, the vehicle front structure 10 of the present exemplary embodiment is integrally molded by aluminum die casting. Here, in the present exemplary embodiment, the left and right pair of front side members 12, the left and right pair of crash boxes 14, the left and right pair of suspension towers 22, and peripheral components of the left and right pair of suspension towers 22—that is, the apron upper members 16, the fender aprons 18, and the dash panel 20—are integrally molded by aluminum die casting.

### (Method of Manufacturing Vehicle Front Structure)

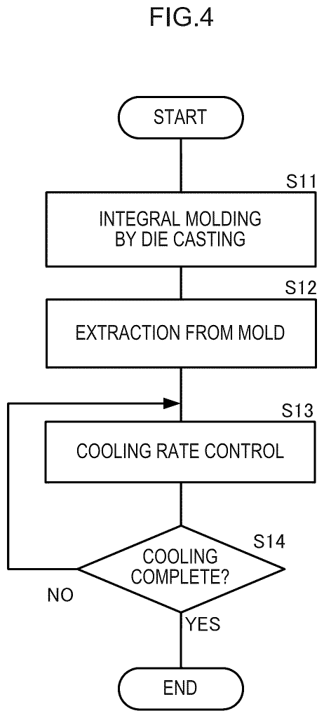

Explanation follows regarding a manufacturing method of the vehicle front structure 10. Note that the vehicle front structure 10 manufactured in the present exemplary embodiment is configured of an aluminum casting-a so-called F material—that has not been subjected to heat treatment. As illustrated in FIG. 4, first, in step S11, an aluminum alloy, serving as a material, is melted at a high temperature and poured into a mold, thereby integrally molding the vehicle front structure 10 by die casting.

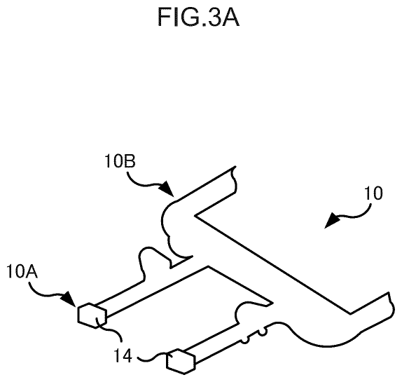

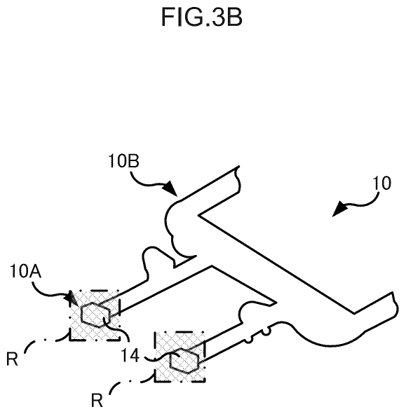

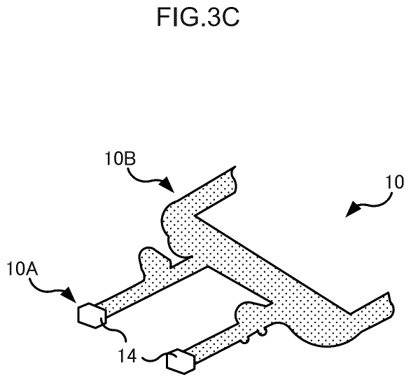

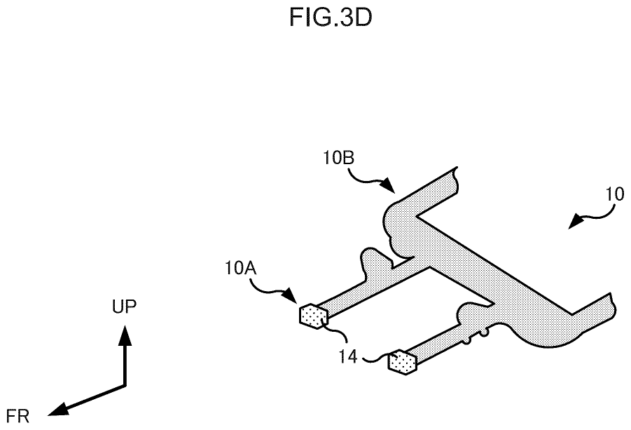

Next, in step S12, after the aluminum alloy poured into the mold has solidified, the vehicle front structure 10 is taken out of the mold. Thus, as illustrated in FIG. 3A, a molded vehicle front structure 10 is obtained. Note that at this time, the vehicle front structure 10 that has been extracted from the mold is in a state in which there is residual heat at a temperature S1 (600° C. as an example). In the present exemplary embodiment, as an example, a portion 10A at the other end side of the vehicle front structure 10 is a crash box 14, serving as a portion at the vehicle front end side, and a portion 10B at the one end side is a portion other than the crash box 14.

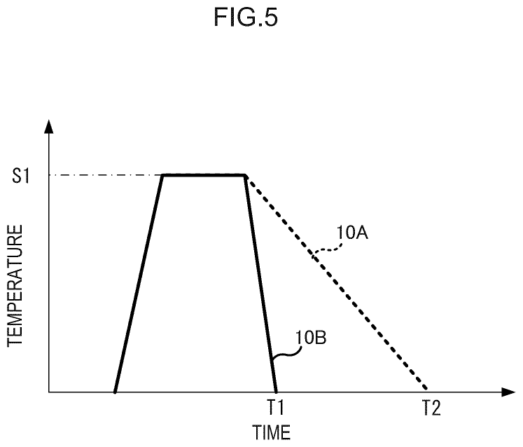

Next, in step S13, the cooling speed of the vehicle front structure 10 is controlled. Specifically, as indicated by the shading inside the dash-dot line frame indicated by the notation R in FIG. 3B, the crash box 14 is surrounded by a wrapping member, such as a blanket, cloth, or a box material, as an example. As illustrated in FIG. 5, while it takes a time T1 for the temperature change of the portion 10B at the one end side, indicated by the solid line, to cool to a predetermined temperature, the crash box 14, which is a portion surrounded by the wrapping member indicated by a dotted line—namely, the portion 10 A at the other end side-takes a time T2, which is longer than the time T1, to cool down to a predetermined temperature. Namely, the portion surrounded by the wrapping member (the portion 10A at the other end side; the crash box 14) has a lower cooling rate than the portion 10B at the one end side.

As illustrated in FIG. 3C, the crash box 14, which is a portion surrounded by a wrapping member, is, owing to the slower cooling rate, exposed to a higher temperature than the portion 10B at the one end side that was not surrounded by the wrapping member. Thus, softening due to precipitation from a high temperature, and softening due to recovery of casting strain are increased in the crash box 14.

When cooling of the vehicle front structure 10 is completed in step S14, manufacturing of the vehicle front structure 10 is completed, as illustrated in FIG. 3D. Namely, the manufactured vehicle front structure 10 has metal properties that are different in the crash box 14 (the portion 10A at the other end side) and in the remaining portion, which is the portion 10B at the one end side. Specifically, the crash box 14 (the portion 10A at the other end side) has lower strength and higher ductility than the portion 10B at the one end side. Note that in cases in which cooling has not been completed in step S14, the treatment of step S13 is performed until cooling is completed.

Thus, the vehicle front structure 10 of the first exemplary embodiment is manufactured.

### (Mechanism and Effect of First Exemplary Embodiment)

Explanation follows regarding the mechanism and advantageous effects of the first exemplary embodiment.

The vehicle front structure 10 according to the first exemplary embodiment is integrally molded by aluminum die casting, and in a structural body forming a vehicle skeleton, the metal properties of a crash box 14 (a portion 10A at the other end) and of a portion other than the crash box 14 (a portion 10B at the one end) are different. Thus, the vehicle front structure 10 according to the first exemplary embodiment has different metal properties in an integrally molded structural body, and different functions corresponding to the respective metal properties can be provided.

The vehicle front structure 10 according to the first exemplary embodiment is a structural body configuring a vehicle front portion, and the crash box 14 (the portion 10A at the other end side) is disposed at the vehicle front side—that is, at the vehicle front direction outer side-relative to the portion other than the crash box 14 (the portion 10B at the one end side). The crash box 14 (the portion 10A at the other end side) has lower strength and higher ductility than the portion other than the crash box 14 (the portion 10B at the one end side).

As a result, the crash box 14 (the portion 10A at the other end side) disposed at the vehicle outer side can be imparted with metal properties of lower strength and higher ductility than portions other than the crash box 14 (the portion 10B at the one end side) disposed at the vehicle inner side. As a result, by imparting the portion at the vehicle outer side with higher ductility than the portion at the vehicle inner side, the energy absorption performance of the portion at the vehicle outer side can be improved. Further, by imparting the portion at the vehicle outer side with lower strength than the portion at the vehicle inner side, the portion at the vehicle inner side can be made harder to deform. Further, because the vehicle inner side portion is stronger than the vehicle outer side portion, since the rigidity of the vehicle inner side portion is higher than the rigidity of the vehicle outer side portion, maneuverability can be improved.

Since the vehicle front structure 10 according to the first exemplary embodiment is the crash box 14, the crash box 14 can be imparted with higher ductility than other portions. This enables the crash box 14 to be integrally molded with other components that require strength.

### Second Exemplary Embodiment

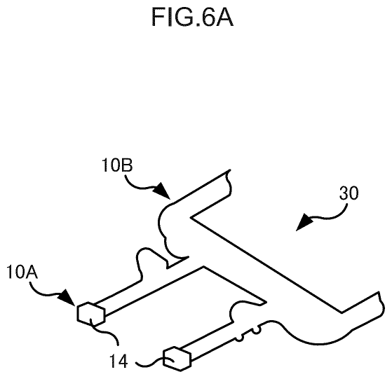

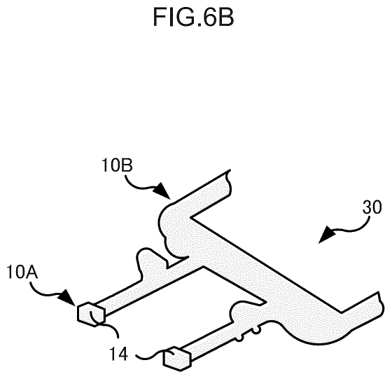

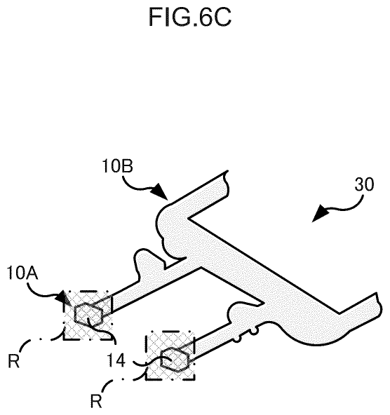

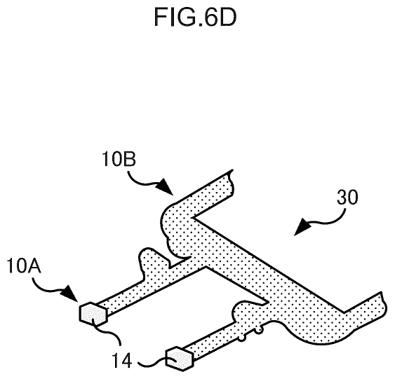

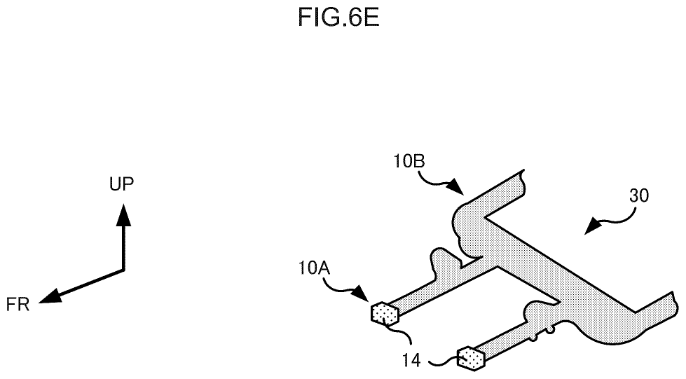

Explanation follows regarding a vehicle front structure 30 serving as a structural body according to a second exemplary embodiment of the present disclosure, with reference to FIGS. 6 to 8. Note that configuration elements that are the same as those in the first exemplary embodiment are denoted by the same reference numerals, and explanation thereof is omitted here, and only different configuration elements are explained.

A vehicle front structure 30 according to a second exemplary embodiment has the same shape as the vehicle front structure 10 according to the first exemplary embodiment; however, a different manufacturing method is used. Specifically, while the vehicle front structure 10 according to the first exemplary embodiment is configured with the F material, the vehicle front structure 30 of the second exemplary embodiment is configured with a heat treated material that is a material obtained by heat treatment of the F material. Note that heat treatment refers to treatment in which the F material, as cast, is heated and held at a high temperature, and then cooled to obtain a predetermined strength. The present exemplary embodiment is configured using a material that has been subjected to treatment such as T6 and T7 of the JIS Standards, in which, after heating the F material, for example, to a temperature of about 500° C. and maintaining the temperature, the material is quenched in cold water or warm water, and then further heated and held at a temperature of about 180° C., as an example, and cooled.

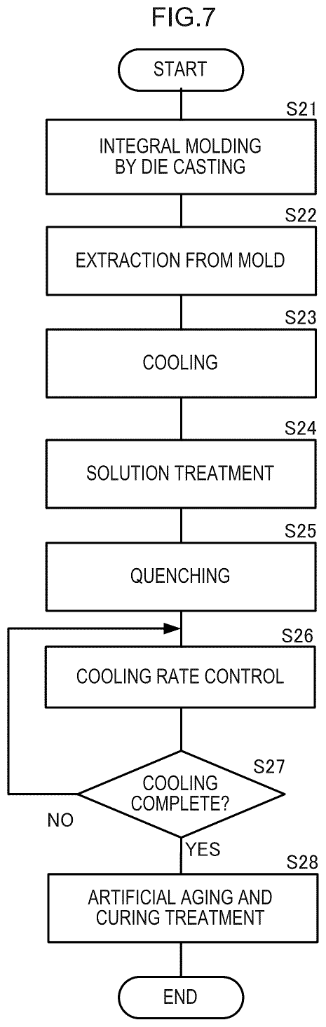

As illustrated in FIG. 7, first, in step S21, the vehicle front structure 30 is integrally molded by die casting, in which an aluminum alloy, serving as a material, is melted at a high temperature and poured into a mold.

Next, in step S22, after the aluminum alloy poured into the mold has solidified, the vehicle front structure 30 is taken out from the mold. As a result, as illustrated in FIG. 6A, the molded vehicle front structure 30 is obtained. Note that at this time, the vehicle front structure 30 that has been extracted from the mold is in a state in which there is residual heat at a temperature S1 (600° C. as an example).

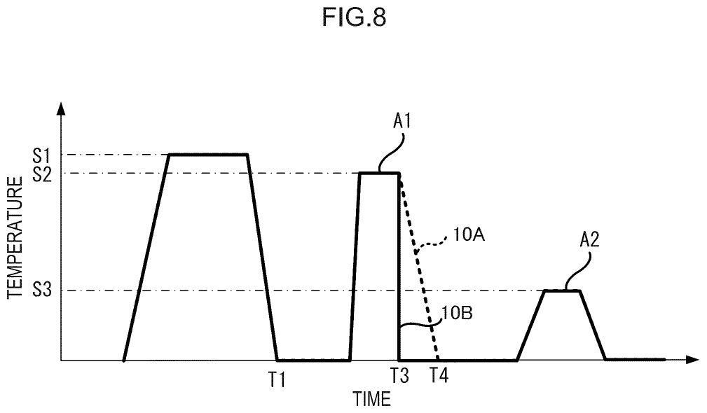

Next, in step S23, the vehicle front structure 30 is cooled to a predetermined temperature. At this time, as illustrated in FIG. 8, time T1 is required. Next, in step S24, solution treatment is performed on the vehicle front structure 30. As illustrated in FIG. 8, the solution treatment A1 is treatment in which the F material is heated to a temperature S2 (about 500° C. as an example) that is maintained for several hours.

Next, in step S25, quenching is performed on the vehicle front structure 30. Quenching is a treatment in which the vehicle front structure 30 is put into warm water after the solution treatment. As illustrated in FIG. 6B, the overall temperature of the vehicle front structure 30 after quenching is reduced.

Next, in step S26, the cooling speed of the vehicle front structure 30 is controlled. Specifically, with respect to the vehicle front structure 30 after the quenching in step S25, as indicated by the shading inside the dot-dash line frame indicated by the notation R in FIG. 6C, the crash box 14 is surrounded by a wrapping member, such as a blanket, cloth, or a box material, as an example. As illustrated in FIG. 8, while a time T3 is required for the temperature change of the portion 10B at the one end side, indicated by the solid line, to cool to a predetermined temperature, the crash box 14, which is the portion surrounded by the wrapping member indicated by a dotted line—namely, the portion 10A at the other end side-takes time T4, which is longer than the time T3, to cool down to a predetermined temperature. Namely, the portion surrounded by the wrapping member (the portion 10A at the other end side; the crash box 14) has a lower cooling rate than the portion 10B at the one end side.

As illustrated in FIG. 6D, in the crash box 14, which is a portion surrounded by a wrapping member, a quench delay occurs owing to the slower cooling rate, and strength does not increase, even when artificial aging and curing (tempering) is performed.

When cooling of the vehicle front structure 30 is completed in step S27, artificial aging and curing treatment is performed on the vehicle front structure 30 in step S28. As illustrated in FIG. 8, the artificial aging and curing treatment A2 is treatment in which the vehicle front structure 30 that has been quenched after being held at the temperature S2 in the solution treatment A1, is heated again at a temperature S3 (about 180° C. as an example). This enables an element that has been dissolved in supersaturation to be artificially precipitated, thereby enabling the hardness of the aluminum alloy to be increased. Since, as described above, a quench delay has occurred in the crash box 14, which is the portion surrounded by the wrapping member, artificial aging and curing treatment does not increase the hardness compared to other portions. Note that in cases in which cooling has not been completed in step S27, the treatment of step S26 is performed until cooling is completed.

When the artificial aging and curing treatment A2 of the vehicle front structure 30 is completed in step S28, manufacturing of the vehicle front structure 30 is completed, as illustrated in FIG. 6E. Namely, the manufactured vehicle front structure 30 has metal properties that are different in the crash box 14 (the portion 10A at the other end side) and in the remaining portion, which is the portion 10B at the one end side. Specifically, the crash box 14 (the portion 10A at the other end side) has lower strength and higher ductility than the portion 10B at the one end side.

In this way, the vehicle front structure 30 of the second exemplary embodiment is manufactured.

### Mechanism and Effect of Second Exemplary Embodiment

Explanation follows regarding the mechanism and advantageous effects of the second exemplary embodiment.

The vehicle front structure 30 according to the second exemplary embodiment is integrally molded by aluminum die casting, and in a structural body that forms a vehicle skeleton, the metal properties of the crash box 14 (the portion 10A at the other end side) and portions other than the crash box 14 (the portion 10B at the one end side) are different from each other. Therefore, in the vehicle front structure 10 according to the first exemplary embodiment, as a result of having different metal properties in an integrally molded structure, different functions corresponding to the respective metal properties can be provided.

Further, the vehicle front structure 30 according to the second exemplary embodiment is a structural body configuring a vehicle front portion, and the crash box 14 (the portion 10A at the other end side) is disposed at the vehicle front side—that is, at the vehicle front direction outer side-relative to the portion other than the crash box 14 (the portion 10B at the one end side). The crash box 14 (the portion 10A at the other end side) has lower strength and higher ductility than the portion other than the crash box 14 (the portion 10B at the one end side).

As a result, the crash box 14 (the portion 10A at the other end side) disposed at the vehicle outer side can be imparted with metal properties of lower strength and higher ductility than portions other than the crash box 14 (the portion 10B at the one end side) disposed at the vehicle inner side. As a result, by imparting the portion at the vehicle outer side with higher ductility than the portion at the vehicle inner side, the energy absorption performance of the portion at the vehicle outer side can be improved. Further, by imparting the portion at the vehicle outer side with lower strength than the portion at the vehicle inner side, the portion at the vehicle inner side can be made harder to deform. Further, because the vehicle inner side portion is stronger than the vehicle outer side portion, since the rigidity of the vehicle inner side portion is higher than the rigidity of the vehicle outer side portion, maneuverability can be improved.

Since the vehicle front structure 30 according to the second exemplary embodiment is the crash box 14, the crash box 14 can be imparted with higher ductility than other portions. This enables the crash box 14 to be integrally molded with other components that require strength.

### Third Exemplary Embodiment

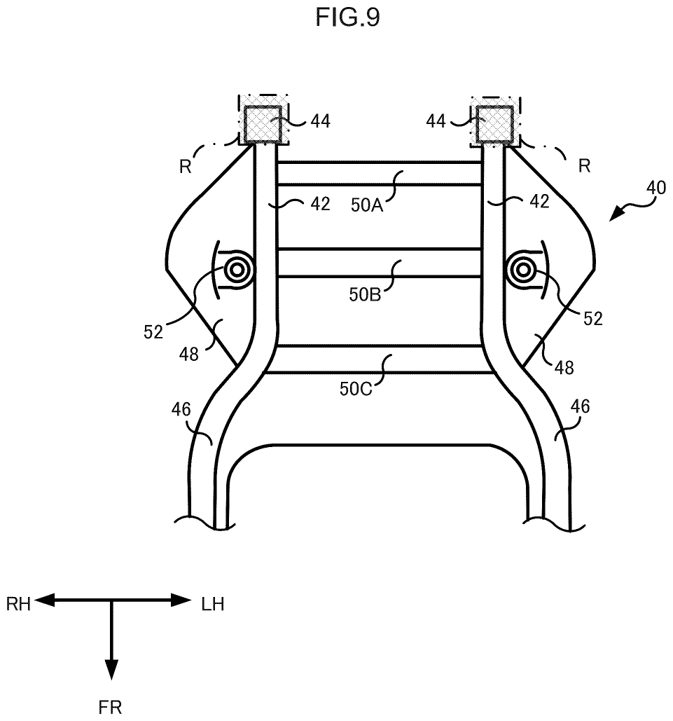

Explanation follows regarding a vehicle rear structure 40 serving as a structural body according to a third exemplary embodiment of the present disclosure, with reference to FIG. 9. The structural bodies of the first and second exemplary embodiments described above are the vehicle front structures 10, 30, while the structural body of the third exemplary embodiment is the vehicle rear structure 40 configuring a vehicle rear portion.

### (Configuration of Vehicle Rear Structure)

As illustrated in FIG. 9, the vehicle rear structure 40 is a rear skeleton member of a vehicle, and includes a left and right pair of rear side members 42 disposed at respective vehicle width direction sides of a vehicle rear portion. The rear side members 42 extend along the vehicle front-rear direction, and an end portion of the rear side member 42 at the vehicle front side is connected to a cross member (not illustrated). A vehicle rear end portion of the rear side member 42 is connected to a rear bumper reinforcement (not illustrated in the drawings; hereinafter, referred to as “rear bumper RF”) disposed along the vehicle width direction. In the present exemplary embodiment, as an example, the rear side member 42 includes a crash box 44 serving as an energy absorption member at a rear end portion connected to the rear bumper RF.

The crash box 44 is configured to deform and absorb some of the energy of the collision prior to the rear side member 42 being deformed when the vehicle is involved in a rear end collision. When an impact load is transmitted from the rear bumper RF to the crash box 44, the crash box 44 is compressed in the front-rear direction.

A left and right pair of apron upper members 46 extending in the vehicle front-rear direction are disposed at the vehicle width direction outer side at the vehicle rear side of the rear side member 42. A left and right pair of fender aprons 48 are disposed at the vehicle width direction outer sides of the rear side members 42 and at the vehicle rear side of the apron upper members 46. The rear side members 42 and the apron upper members 46 each have a substantially rectangular cross-section shape that is open at the vehicle width direction outer side.

Plural cross members 50A, 50B, and 50C extending in the vehicle width direction are disposed at the vehicle rear side of the rear side members 42 and between the left and right pair of apron upper members 46.

A suspension tower 52 is provided at a vehicle upper side at the vehicle width direction outer side and the vehicle rear side of the rear side member 42. A vehicle lower side of the suspension tower 52 is joined to the fender apron 48, and the fender apron 48 is formed swollen toward the vehicle width direction inner side, and a wheel house, not illustrated in the drawings, in which a front wheel is housed so as to be capable of being steered, is also formed.

The suspension tower 52 is provided projecting in a substantial tube shape toward the vehicle upper side from the wheel house—namely, from the swollen portion—of the fender apron 48. A shock absorber and a spring configuring a suspension, not illustrated in the drawings, that supports a rear wheel housed in the wheel house of the fender apron 48 are housed inside the suspension tower 52.

Further, as an example, the vehicle rear structure 40 of the present exemplary embodiment is integrally molded by aluminum die casting. Here, in the present exemplary embodiment, the left and right pair of rear side members 42, the left and right pair of crash boxes 44, the left and right pair of suspension towers 52, and peripheral components of the left and right pair of suspension towers 52—namely, the apron upper member 46, the fender apron 48, and the plural cross members 50A, 50B, 50C—are integrally molded by aluminum die casting.

### (Method of Manufacturing Vehicle Rear Structure)

Explanation follows regarding a method of manufacturing the vehicle rear structure 40. Note that the vehicle rear structure 40 manufactured in the present exemplary embodiment is configured by the F material similarly to in the first exemplary embodiment above, or is configured with a heat treated material similarly to in the above second exemplary embodiment. In the first exemplary embodiment and the second exemplary embodiment, in order to slow down the cooling rate of the crash box 14 serving as the other end side portion 10A, as an example, the crash box 14 is surrounded by a wrapping member such as a blanket, cloth, or a box material. In this regard, in the vehicle rear structure 40 serving as a structural body of the third exemplary embodiment, in order to slow down the cooling rate of the crash box 44, as an example, the crash box 44 is surrounded by a wrapping member such as a blanket, cloth, or a box material.

Namely, in the third exemplary embodiment, the crash box 44 is configured as the other end side portion 10A, and as the manufacturing method, the same methods as in the above first exemplary embodiment and the above second exemplary embodiment are employed, for the remaining portion that is the one end side portion 10B.

### Mechanism and Effect of Third Exemplary Embodiment

Explanation follows regarding the mechanism and advantageous effects of the third exemplary embodiment.

The vehicle rear structure 40 according to the third exemplary embodiment can obtain the same advantageous effects as in the first exemplary embodiment and the second exemplary embodiment.

### Modified Example

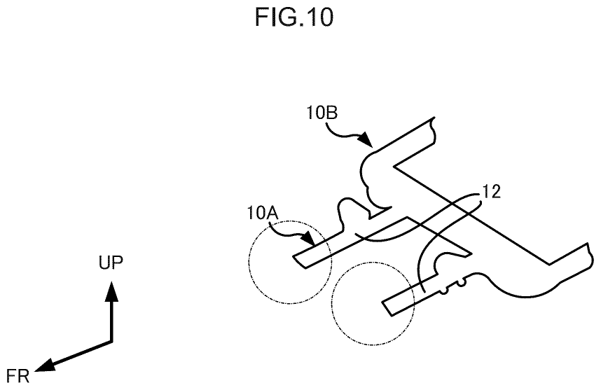

In the above exemplary embodiments, the crash box 14 is the other end side portion 10A, and the remaining portion is the one end side portion 10B; however, the present disclosure is not limited to this. For example, in cases in which the crash box 14 is not integrally molded by aluminum die casting, but is provided as a separate body from the vehicle front structures 10, 30, as illustrated in FIG. 10, the front end portion of the front side member 12 is employed as a portion including at least a part of the front side member 12, and this front end portion may be the other end side portion 10A.

In this kind of modified example, since the other end side portion 10B is a portion including at least a part of the front side member 12, the portion including at least a part of the front side member 12 can be imparted with higher ductility than other portions. This enables a portion that is not to be deformed and a portion that is to be deformed to be integrally molded, and the energy absorption performance of the portion including at least a part of the front side member 12 can be improved.

Although not illustrated in the drawings, in a case in which the crash box 44 is provided separately in the vehicle rear structure 40 in the same manner, a rear end portion of the rear side member 42 may be employed as a portion including at least a part of the rear side member 42, and this rear end portion may be the other end side portion 10A.

### Supplementary Explanation

Note that in the above exemplary embodiments, the vehicle front structures 10, 30 and the vehicle rear structure 40 are integrally molded by aluminum die casting; however, the present disclosure is not limited to this. For example, the structural body may be integrally molded by die casting using a material other than aluminum.

In the above exemplary embodiments, the vehicle front structures 10, 30 and the vehicle rear structure 40 are employed as structural bodies; however, the present disclosure is not limited to this. For example, only one of the left and right pair of front side members 12 may be employed, or only one of the left and right pair of rear side members 42 may be employed, as a structural body.

Although exemplary embodiments of the present disclosure have been explained above, the present disclosure is not limited to such exemplary embodiments, the exemplary embodiments and various modified examples may be used in combination as appropriate, and it will be apparent that the present disclosure may be practiced in various aspects so long as it does not depart from the gist of the present disclosure.

1. A structural body, which is integrally molded by die casting and which is configured to form a vehicle skeleton, the structural body comprising a first portion at one end side and a second portion at another end side, the first and second portions respectively having different metal properties.

2. The structural body of claim 1, wherein:
the structural body configures a vehicle front portion or a vehicle rear portion, and
the second portion is disposed at an outer side, in a vehicle front-rear direction, relative to the first portion, and the second portion has a metal property that is at least one of lower strength or higher ductility than the first portion.

3. The structural body of claim 2, wherein the second portion includes at least a part of a front side member.

4. The structural body of claim 3, wherein the second portion, which includes at least a part of a front side member, comprises a crash box.
